(19) United States
(12) Patent Application Publication
(10) Pub. No.: US 2022/0271379 A1
(43) Pub. Date: Aug. 25, 2022

(54) BATTERY BOX

(71) Applicant: Lippert Components, Inc., Elkhart, IN (US)

(72) Inventors: Vincent SMITH, Edgefield, SC (US); Dominic LAYNE, South Bend, IN (US); Timothy D. SCHULTZ, Mishawaka, IN (US)

(21) Appl. No.: 17/677,214

(22) Filed: Feb. 22, 2022

Related U.S. Application Data
(60) Provisional application No. 63/151,313, filed on Feb. 19, 2021.

(51) Int. Cl. H01M 50/249; H01M 50/574; B60R 16/033

(52) U.S. Cl. CPC H01M 50/249; H01M 50/574; B60R 16/033; H01M 2220/20

(57) ABSTRACT

A battery box attachable to a trailer frame includes a main compartment having a front, a back, and two sides, a base below the main compartment, and a sub-compartment disposed in the main compartment. The base and the main compartment define outer shoulders such that the two sides of the main compartment extend wider than a width of the base. A door is pivotally attached to the main compartment and is configured to close the sub-compartment. The door defines the one of the two sides. A battery box or junction box may include a compartment with a lid for enclosing wire connections and a grounding bar positioned in the compartment. The grounding bar serves as a battery ground, and the grounding bar secures the battery box or junction box through a compartment wall to the trailer frame. The overall assembly helps to simplify wiring between the batteries and the trailer.

### CROSS-REFERENCES TO RELATED APPLICATIONS

This application claims the benefit of U.S. Provisional Patent Application No. 63/151,313, filed Feb. 19, 2021, the entire content of which is herein incorporated by reference.

### STATEMENT REGARDING FEDERALLY SPONSORED RESEARCH OR DEVELOPMENT

(Not Applicable)

### BACKGROUND

The invention relates to a battery box and, more particularly, to a battery box cooperable with a trailer A-frame to secure batteries for operation of vehicle components.

Commonly in recreational vehicles (RVs) and trailers, it is necessary to have battery power and electrical wiring on the outside of the vehicle/trailer for utilizing electronic features and necessities. This can include vehicle or trailer brakes, vehicle lights, general power for running utilities inside of the vehicle, aesthetic lighting, entertainment accessories, or any other feature of an RV that requires electricity. More specifically, it is necessary to have an electrical connection from the tow vehicle to the trailer, and from the trailer, the electrical connection must branch out and be routed to multiple designated locations. In many cases, this requires wires to be routed around, through, and underneath the frame and structure of the vehicle to properly power everything.

Presently, a long vehicle electrical cord is required because the junction box is mounted behind the front cross member of the towed vehicle to protect it from the elements. The junction box is unsightly and is preferred to be hidden from view. Circuit breakers tend to also be located behind the front cross member for the same reasons. The vehicle batteries, however, are typically mounted on the A-frame of the trailer chassis as they are heavy and would be difficult to install into a storage compartment in the vehicle. This location is also necessary because batteries need to be vented. The existing construction thus necessitates the use of a number of additional “pigtail” wires to run back and forth to various components and then out to the A-frame to connect to electrical devices that are located on the A-frame.

For example, battery power is needed to run the trailer brakes in case the breakaway switch is pulled, and the towed vehicle becomes disconnected from the towing vehicle while in motion. The battery wire runs from the A-frame, back behind the front cross member to the circuit breakers. From the breakers, the wire runs via pigtail to the junction box where it is attached to the breakaway switch power wire. The breakaway switch power wire runs forward to the front of the A-frame, where the switch is mounted. From the switch, the breakaway brake wire runs back to the junction box, where it is attached to the trailer brake positive wire.

The battery switch is another example. As the location of the switch moves further away from the battery, more wiring is needed. Current vehicles may have the battery wire running from the battery in the A-frame to the breaker in the front cross member, then forward to the front wall of the towed vehicle where it connects to the switch inside of a storage compartment, and then down to the chassis frame of the towed vehicle where it connects to a secondary distribution center. This construction necessitates about ten extra feet of wire.

RV and mobile home manufacturers typically gather the electrical components needed for fully powering the structure from multiple vendors, usually at the lowest price point. As in the examples above, this causes the manufacturers to have to connect the electrical components in any way they can, as the individual parts may have a necessary mounting or wiring location on the vehicle or chassis that is not convenient for coupling and wiring with the other components. This causes a disorganized and oftentimes tangled display of wires and other electrical components, which is aesthetically unpleasant, dangerous for the user, and not easily serviceable.

### SUMMARY

The battery box according to an exemplary embodiment is configured to support up to two 6-volt or Group 24 batteries. The battery box may be shaped to fit inside of the open space of the trailer chassis A-frame between the tongue jack and the camper/enclosure. The exterior of the box may include a lid that can be opened from either of the front or the back by latches. The lid protects the batteries from water and other outdoor elements. The bottom of the exemplary battery box may include apertures that can be used for venting and allow for securing nylon straps that hold the batteries in place. The batteries can be accessed by removing the lid. The lid may be angled downward from an apex in the form of an upside-down V, which facilitates water and dirt removal. The exterior of the box may include a hook feature right above the nesting portion of the box, which can be optionally used for installing a solar plug.

The exemplary battery box includes a lockable sub-compartment on the side of the main housing that is accessible when the box is nested into the A-frame. The sub-compartment houses thermal breakers, electrical connections, and a grounding bar. The manufacturer can install rubber grommets on the bottom or side wall of the compartment for routing wires in and out of the box. Located inside the sub-compartment is a high current battery disconnect switch between the compartment and the battery.

Both sides of the box may have an aluminum grounding strap that serves a dual purpose of securing the box to the A-frame and serving as a battery ground. The integrated grounding bar removes the need for a separate and sometimes distantly placed ground bar, and in the exemplary assembly, it is protected from outdoor elements. Additionally, a junction box embodiment may include a similar aluminum grounding strap for securing the junction box to the trailer frame and serving as a battery ground.

The battery box of the described embodiment helps to simplify wiring between the batteries and the trailer.

In an exemplary embodiment, a battery box attachable to a trailer frame includes a main compartment having a front, a back, and two sides, and a base below the main compartment. The base and the main compartment define outer shoulders such that the two sides extend wider than a width of the base. A sub-compartment is disposed in the main compartment adjacent one of the two sides, and a door pivotally attached to the main compartment is configured to close the sub-compartment. The door defines the one of the two sides.

The door may include a lock.

The outer sides of the base may be angled to fit inside an A-shaped opening of a trailer frame, where the two sides of the main compartment are configured to set on the trailer frame. The battery box may also include a grounding bar positioned in the sub-compartment and connectable to the trailer frame. An additional grounding bar may be positioned in the main compartment adjacent the other of the two sides and connectable to the trailer frame. Thermal breakers and electrical connections that link breaker power inputs may also be positioned in the sub-compartment.

The battery box may include a battery disconnect switch in the sub-compartment.

A lid may be secured on the main compartment with a plurality of latches. The lid may be inverse V-shaped. An edge of the lid may include vent openings.

In some embodiments, the main compartment may include strap openings in a bottom thereof, where the battery box further includes straps secured in the strap openings that are configured to secure batteries in the battery box.

In another exemplary embodiment, a battery box attachable to a trailer frame includes a main compartment having a front with a first width, a back with a second width, larger than the first width, and two sides connected at an angle between the front and the back, and a base cooperable with the main compartment with front and back width dimensions smaller than the first and second widths, respectively, such that the two sides of the main compartment extend wider than a width of the base. A sub-compartment is disposed in the main compartment, and a lockable door pivotally attached to the main compartment is configured to close the sub-compartment.

In yet another exemplary embodiment, a battery box or junction box attachable to a trailer frame includes a compartment with a lid for enclosing wire connections, and a grounding bar positioned in the compartment. The grounding bar serves as a battery ground, and the grounding bar secures the battery box or junction box through a wall of the compartment to the trailer frame.

### BRIEF DESCRIPTION OF THE DRAWINGS

These and other aspects and advantages will be described in detail with reference to the accompanying drawings, in which:

FIG. 1 is a perspective view of an exemplary battery box;

FIG. 2 shows the exemplary battery box secured in the A-frame of a trailer chassis;

FIG. 3 is a front view of the battery box including a lid;

FIG. 4 is a front view of the battery box with the lid removed;

FIG. 5 is a side-view of the battery box showing a sub-compartment;

FIG. 6 is a perspective view of the battery box;

FIG. 7 is a plan view of the battery box;

FIG. 8 shows the battery box without batteries and including straps for securing the batteries;

FIG. 8A is a bottom view of the box;

FIG. 8B is a detailed view showing ribs that create a gap for venting;

FIG. 9 shows the battery box including batteries secured in place with straps;

FIG. 10 is a top view of a junction box with a lid and including a grounding strap;

FIG. 11 is a top view of the interior components of the junction box of FIG. 10; and

FIG. 12 is a perspective view of the exterior of the junction box of FIG. 10.

### DETAILED DESCRIPTION

With reference to the drawings, a battery box 10 is attachable to a trailer frame TF. In some embodiments, with reference to FIG. 2, the battery box 10 may be configured to fit into the open space of a trailer chassis A-frame between the tongue jack and the towed vehicle.

The battery box 10 includes a main compartment 12 with a front 14, a back 16, and two sides 18, 20. For reference, in the embodiment with the battery box 10 secured in the trailer A-frame, the front 14 of the main compartment 12 is forward relative to the direction of forward travel.

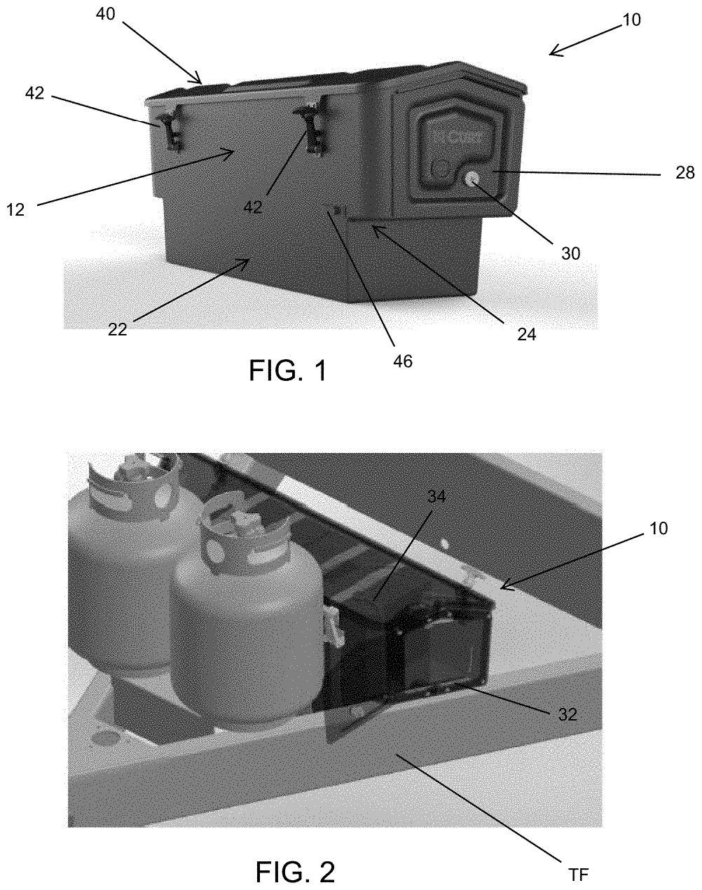

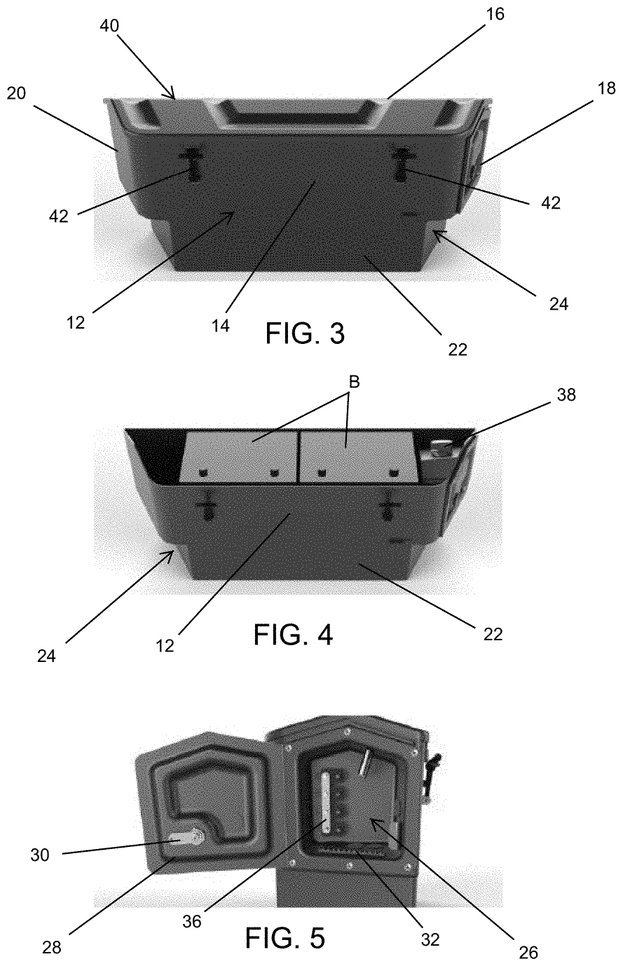

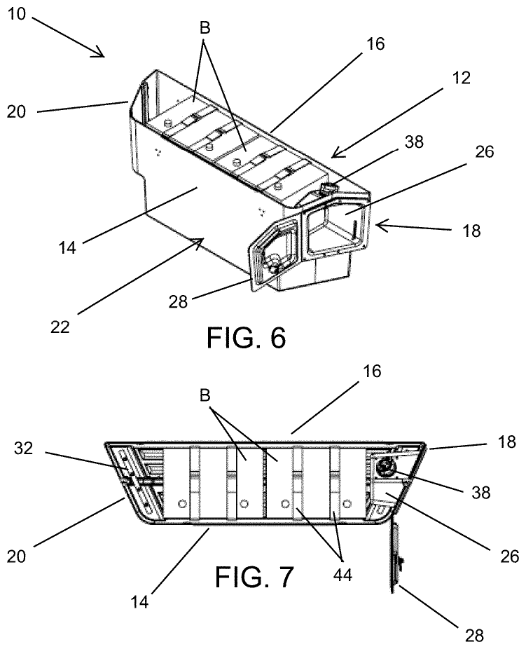

A base 22 is positioned below the main compartment 12. With particular reference to FIGS. 1, 3 and 4, the base 22 and main compartment 12 define outer shoulders 24 such that the two sides 18, 20 extend wider than a width of the base 22. As shown in FIGS. 3 and 4 for example, the battery box 10 thus assumes a T-shape when viewed from the front or the back to fit in the trailer A-frame.

A sub-compartment 26 is disposed in the main compartment 12 adjacent one of the two sides 18, 20. A door 28 is pivotally attached to the main compartment 12 and is configured to close the sub-compartment 26. As shown in FIG. 1, for example, the door 28 defines one of the two sides 18, 20. In some embodiments, the door 28 includes a keyed or thumb twist lock 30.

With particular reference to FIGS. 3 and 4, the front 14 of the main compartment 12 may have a first width, and the back 16 may have a second width, larger than the first width. As such, the two sides 18, 20 may be connected at an angle between the front and the back. Similarly, the outer sides of the base 22 may be angled to fit inside the A-shaped opening of the trailer frame TF, with the two sides 18, 20 of the main compartment 12 sized to sit on the trailer frame TF. That is, the trailer frame TF fits in the shoulders 24 between the base 22 and the main compartment 12.

With reference to FIGS. 5 and 7-9, a grounding bar 32 in the form of an aluminum strap or the like may be positioned in the sub-compartment 26 and/or adjacent the opposite side of the main compartment 12. In some embodiments, the battery box 10 may be secured to the trailer A-frame through the grounding bar(s) 32. A ground link 34 (FIG. 2) may be connected between the batteries B and the grounding bar(s) 32 to provide a ground for the batteries B. The grounding bars 32 thus serve a dual purpose of securing the battery box 10 to the A-frame and serving as the battery ground. The integrated grounding bars 32 and ground link 34 remove the need for a separate and sometimes distantly-placed ground bar, and in the described embodiments, are protected from outdoor elements.

The sub-compartment 26 also houses thermal breakers and electrical connections via an aluminum bus bar 36. The thermal breakers and electrical connections serve to link breaker power inputs. The bus bar 36 distributes power from one breaker to the next and allows for the breakers to be installed in close proximity, which reduces the overall footprint. The battery box 10 may include rubber grommets or the like on the bottom or side wall of the main compartment 12 for routing wires in and out of the box 10.

A high current battery disconnect switch 38 may be positioned in the main compartment 12 and electrically connected with the batteries B. As shown in FIG. 4, for example, the disconnect switch 38 is positioned on the sub-compartment 26 within the main compartment 12.

The box 10 may also include a lid 40 that can be opened from either the front or the back via latches 42. The batteries B can be accessed by removing the lid 40 via the latches 42. In some embodiments, the latches 42 are pivoted upward and pulled into a locking position with a U- or C-shaped catch that is connected to the lid 40. The lid 40 protects the batteries B from water and other outdoor elements. An edge of the lid 40 may be provided with integrated apertures for venting. Alternatively or additionally, there may be a gap around the lid 40 to act as a vent. In some embodiments, the lid 40 is inverse V-shaped as shown in, for example, FIG. 1, which facilitates water and dirt removal.

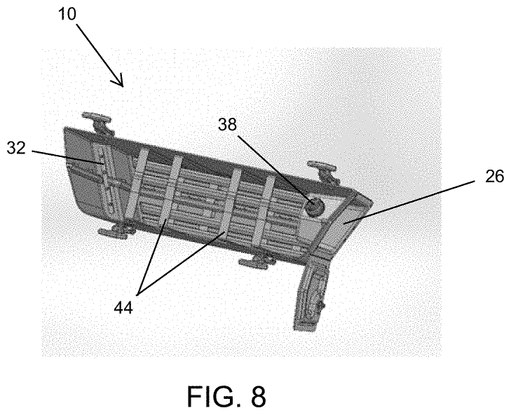

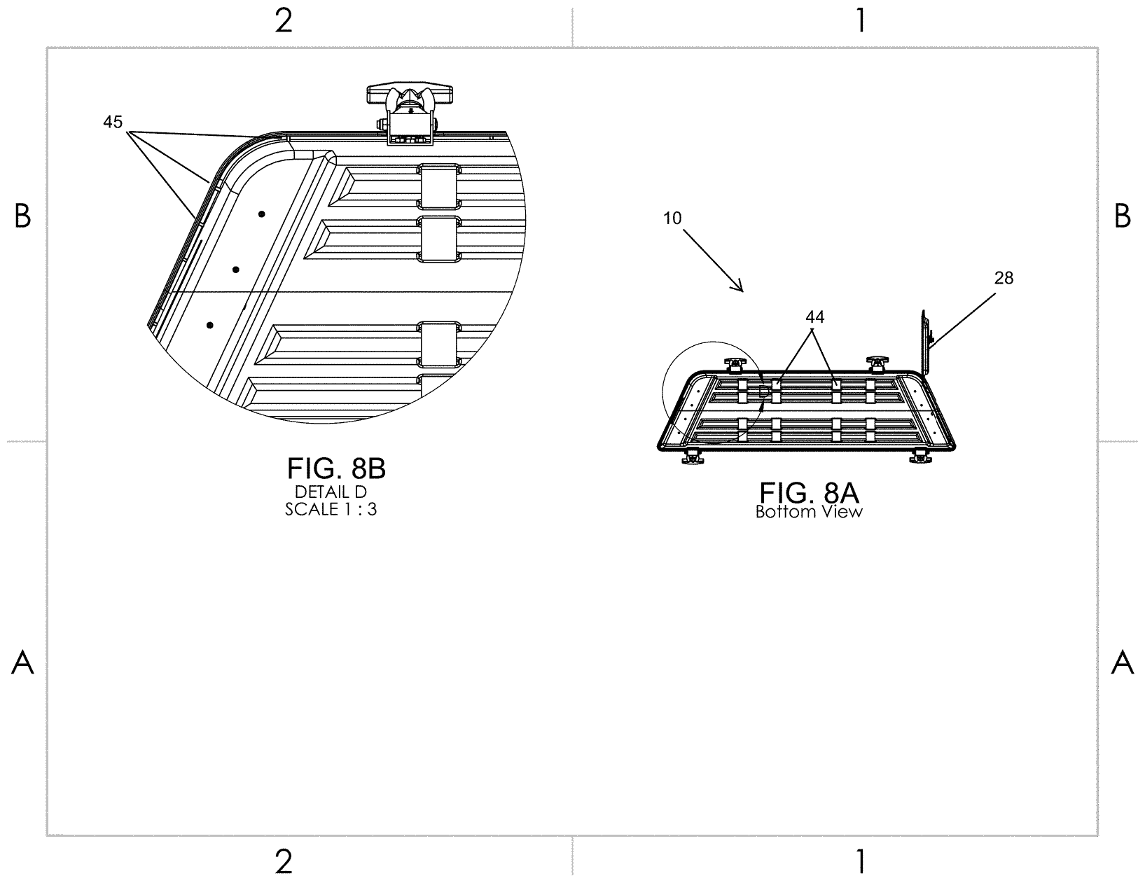

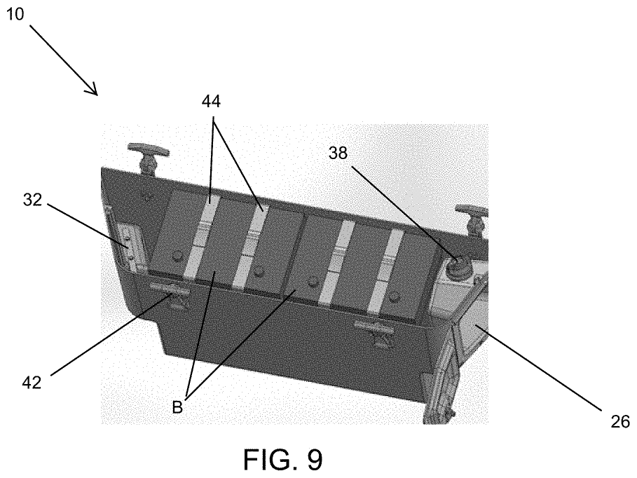

With reference to FIG. 8, for example, a bottom of the box 10 may be provided with apertures that can be used for venting but also allow for securing nylon or other suitable material straps 44 that secure the batteries B in place. FIG. 8 shows the apertures in the battery box 10 and the straps 44 without the batteries. FIG. 8A is a bottom view of the box 10, and FIG. 8B is a detailed view showing ribs 45 that create a gap for venting. FIG. 9 shows the batteries B secured in the box 10 with the straps 44.

The exterior of the box 10 may also be provided with a hook feature 46 (see FIG. 1) above the nesting portion of the box 10, which can be optionally used for installing a solar plug.

Other features contemplated in the current design include wireless operation of the battery disconnect switch 38 (e.g., via Bluetooth), integration of an isolator, and implementing a load monitoring system. The battery box 10 may also include a padlock option to protect the batteries B stored inside the battery box 10 from theft.

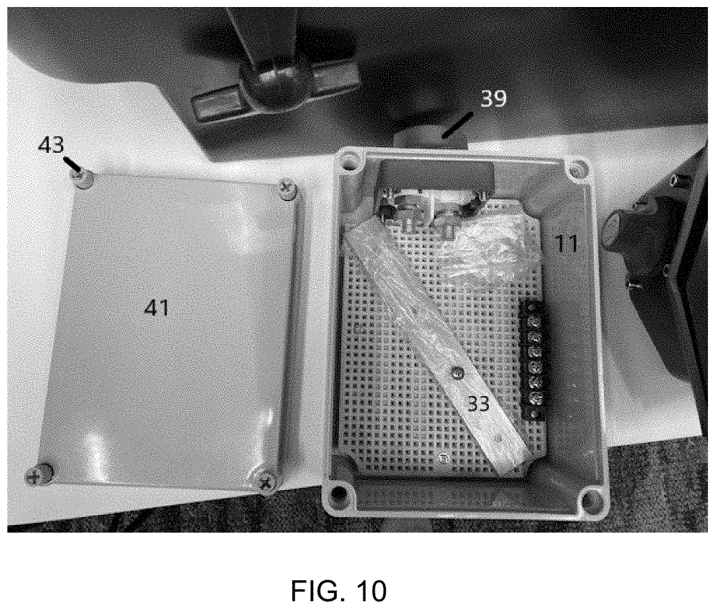

With reference to FIG. 10, a junction box embodiment may include a case 11 with a lid 41 for enclosing wire connections. In this embodiment, a grounding bar 33 in the form of an aluminum strap or the like may be positioned on one of the walls of the case 11 and may serve the dual purpose of securing the junction box through the wall of the case to the trailer frame TF and serving as the battery ground. A ground link (not shown) may be connected between the batteries and the grounding bar 33 to provide a ground for the batteries. One or more openings (not shown) may be provided in the walls of the case 11 for allowing wires or cables (not shown) to enter the junction box.

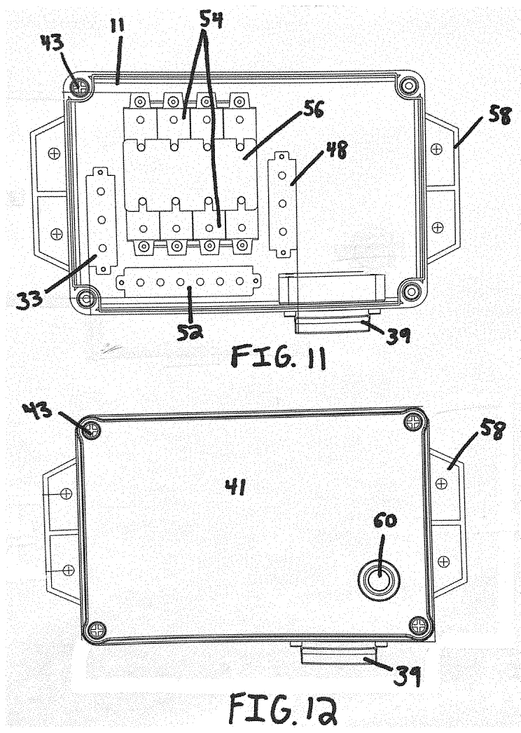

With reference to FIG. 11, the lid 41 may include a seal (not shown) and use fasteners 43 or the like to removably mount to the case 11 to protect the electrical connections from external elements. In some embodiments, one wall of the case 11 may include a battery disconnect switch 39. The interior of the case 11 may include a power-in assembly 48 with terminal connections, preferably near an opening in the case for receiving wires. The case 11 may also include other components such as a trailer connection assembly 52, mini breakers 54, and a bus bar 56.

With reference to FIG. 12, the lid 41 of the junction box may include a motion-activated LED light 60. The motion-activated LED light 60 may illuminate the area around the junction box for a user in dark or low-visibility conditions. The case 11 may optionally include one or more mounting flanges 58 for supplemental securement of the case to the trailer frame in an embodiment where the grounding bar 33 is short and may not support the full weight of the junction box when secured.

The overall assembly helps to simplify wiring between the batteries and the trailer.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A battery box attachable to a trailer frame, the battery box comprising:
a main compartment having a front, a back, and two sides;
a base below the main compartment, wherein base and the main compartment define outer shoulders such that the two sides extend wider than a width of the base;
a sub-compartment disposed in the main compartment adjacent one of the two sides; and
a door pivotally attached to the main compartment and configured to close the sub-compartment, the door defining the one of the two sides.

2. A battery box according to claim 1, wherein the door comprises a lock.

3. A battery box according to claim 1, wherein outer sides of the base are angled to fit inside an A-shaped opening of a trailer frame, wherein the two sides of the main compartment are configured to set on the trailer frame.

4. A battery box according to claim 3, further comprising a grounding bar positioned in the sub-compartment and connectable to the trailer frame.

5. A battery box according to claim 4, further comprising an additional grounding bar positioned in the main compartment adjacent the other of the two sides and connectable to the trailer frame.

6. A battery box according to claim 4, further comprising thermal breakers and electrical connections that link breaker power inputs, the thermal breakers and the electrical connections being positioned in the sub-compartment.

7. A battery box according to claim 1, further comprising a battery disconnect switch in the sub-compartment.

8. A battery box according to claim 1, further comprising a lid secured on the main compartment with a plurality of latches.

9. A battery box according to claim 8, wherein the lid is inverse V-shaped.

10. A battery box according to claim 9, wherein an edge of the lid comprises vent openings.

11. A battery box according to claim 1, wherein the main compartment comprises strap openings in a bottom thereof, the battery box further comprising straps secured in the strap openings that are configured to secure batteries in the battery box.

12. A battery box attachable to a trailer frame, the battery box comprising:
a main compartment having a front with a first width, a back with a second width, larger than the first width, and two sides connected at an angle between the front and the back;
a base cooperable with the main compartment with front and back width dimensions smaller than the first and second widths, respectively, such that the two sides of the main compartment extend wider than a width of the base;
a sub-compartment disposed in the main compartment; and
a lockable door pivotally attached to the main compartment and configured to close the sub-compartment.

13. A battery box according to claim 12, further comprising a grounding bar positioned in the sub-compartment and connectable to the trailer frame.

14. A battery box according to claim 13, further comprising an additional grounding bar positioned in the main compartment on an opposite side of the main compartment from the sub-compartment.

15. A battery box according to claim 12, further comprising a battery disconnect switch in the sub-compartment.

16. A battery box according to claim 12, further comprising a lid secured on the main compartment.

17. A battery box according to claim 16, wherein the lid is inverse V-shaped.

18. A battery box according to claim 12, wherein the main compartment comprises strap openings in a bottom thereof, the battery box further comprising straps secured in the strap openings that are configured to secure batteries in the battery box.

19. A battery box or junction box attachable to a trailer frame, the battery box or junction box comprising a compartment with a lid for enclosing wire connections, and a grounding bar positioned in the compartment, wherein the grounding bar serves as a battery ground, and wherein the grounding bar secures the battery box or junction box through a wall of the compartment to the trailer frame.
